(19) United States
(12) Patent Application Publication
(10) Pub. No.: US 2026/0073092 A1
(43) Pub. Date: Mar. 12, 2026

(54) HYBRID SENSOR NETWORK IN AUTOCLAVING OF PRE-FILLED VIALS

(71) Applicant: Pfizer Inc., New York, NY (US)

(72) Inventor: Kirk ROFFI, Billerica, MA (US)

(21) Appl. No.: 19/323,050

(22) Filed: Sep. 9, 2025

Related U.S. Application Data
(60) Provisional application No. 63/692,419, filed on Sep. 9, 2024.

(51) Int. Cl. G06F 30/20; G06F 119/14

(52) U.S. Cl. CPC G06F 30/20; G06F 2119/14

(57) ABSTRACT

Method and system of packaging a pre-filled vial. The method includes simulating, in a processor of a computing system based at least in part on a simulation model that includes a proportional-integral-derivative (PID) controller block, a frictional disengaging of a stopper that is engaged with the pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper. Generating, by the processor based on the progressively varying physical conditions, a measure corresponding to a stopper displacement in accordance with the frictional disengaging, and packaging the pre-filled vial based at least in part on the generated stopper placement.

### CROSS-REFERENCE TO RELATED APPLICATIONS

This application claims the benefit of U.S. Provisional Patent Application No. 63/692,419, filed on Sep. 9, 2024, of which is incorporated herein by reference in its entirety.

### TECHNICAL FIELD

The disclosure herein relates to digital simulation of physical effects upon container systems and devices.

### BACKGROUND

Autoclaving can be used to sterilize containers, including glass and plastic containers using steam at high temperatures and pressures to kill microorganisms and spores. Current techniques for autoclaving pre-filled vials, including pre-filled syringes containing drug constituents, are expensive, time- and manpower-consuming to conduct, and significantly, may be subject to inaccuracies and errors introduced due to reliability, repeatability and tolerance variation limitations inherent to sensor devices and other measurement equipment deployed in hostile physical conditions of the autoclave chambers.

### BRIEF DESCRIPTION OF THE DRAWINGS

FIG. 1 illustrates, in an example embodiment, a pre-filled vial configured for autoclaving.

FIG. 2 illustrates, in an example embodiment, a scheme for digital simulation based on hybrid sensor network in autoclaving of a pre-filled vial.

FIG. 3 illustrates, in an example embodiment, a computing device architecture for digital simulation based on a hybrid sensor network in autoclaving of a pre-filled vial.

FIG. 4 illustrates, in an example embodiment, an architecture of a proportional-integral-derivative (PID) controller block for digital simulation based on a hybrid sensor network in autoclaving of a pre-filled vial.

FIG. 5 illustrates, in an example embodiment, a method of operation based on a hybrid sensor network in autoclaving for packaging a pre-filled vial.

FIG. 6 illustrates, in an example embodiment, a method of deploying a simulation model based on a hybrid sensor network in designing an autoclave process for the pre-filled vial.

FIG. 7 illustrates, in an example embodiment, a method of deploying a simulation model based on a hybrid sensor network in real time control of an autoclave operation performed on a pre-filed vial.

### DETAILED DESCRIPTION

Among other benefits and advantages, embodiments herein provide systems and techniques in order to maintain and ensure integrity of pre-filled vials and contents therein when subjected to high pressures and temperatures during the autoclaving process. Embodiments deploy a digital simulation model using a combination of physical and virtual sensors, constituting a hybrid sensor network, that ensure integrity of pre-filled vials and contents when subjected to high pressures and temperatures during autoclaving. In particular, embodiments herein provide a virtual sensor based at least in part upon a modeling framework derived from a tribology perspective and friction compensation methods, applying data-based friction compensation via a proportional-integral-derivative (PID) controller block to simulate displacement profile of a stopper that encloses the contents of a pre-filled vial. Given the practical limitations of measuring frictional parameters in-situ under the harsh physical conditions of an autoclave chamber, a virtual sensing approach is provided herein, to perform a realistic, friction-compensated pressure balance across the stopper during autoclaving to infer the stopper dynamics, including displacement and velocity, via numerical integration. In embodiments, the stopper displacement profile is applied with a goal of controlling and preventing, or sufficiently inhibiting. stopper motion within the pre-filled vial to ensure integrity of the pre-filled vial and its constituents.

Provided is a method of packaging a pre-filled vial. The method includes simulating, in a processor of a computing system based at least in part on a simulation model that includes a proportional-integral-derivative (PID) controller block, a frictional disengaging of a stopper that is engaged with the pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper. Generating, by the processor based on the progressively varying physical conditions, a measure corresponding to a stopper displacement in accordance with the frictional disengaging, and packaging the pre-filled vial based at least in part on the generated stopper placement.

In embodiments, the pre-filled vial comprises a pre-filled syringe. The vial may be constructed of a glass or a polymer material, and also any combination thereof. The stopper may be constructed of an elastomer material, such as, but not limited to, rubber.

In some embodiments, the digital simulation model may based on a proportional-integral-derivative (PID) controller block that includes a PID observer. In some aspects, the PID observer models frictional mechanics of the stopper relative to a surface of the pre-filled vial with which the stopper is engaged in accordance with a PID friction compensation model. In some particular embodiments, the PID friction compensation model is based at least in part upon elastomer-glass surface asperities and frictional characteristics inherent thereto.

Also provided is an apparatus for packaging a pre-filled vial. The apparatus includes one or more processors and a memory storing instructions executable in the one or more processors. The instructions when executed cause the one or more processors to implement operations comprising simulating, in the one or more processors based at least in part on a simulation model that includes a proportional-integral-derivative (PID) controller block, a frictional disengaging of a stopper that is engaged with the pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper, generating, by the one or more processors based on the progressively varying physical conditions, a measure corresponding to a stopper displacement in accordance with the frictional disengaging, and packaging the pre-filled vial based at least in part on the generated stopper displacement.

Also provided is a non-transitory computer-readable memory storing instructions, the instructions being executable in one or more processor devices to cause the one or more processor to perform operations comprising simulating, based at least in part on a simulation model that includes a proportional-integral-derivative (PID) controller block, a frictional disengaging of a stopper that is engaged with the pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper, generating, by the one or more processors based on the progressively varying physical conditions, a measure corresponding to a stopper displacement in accordance with the frictional disengaging, and packaging the pre-filled vial based at least in part on the generated stopper displacement.

Embodiments described herein can be implemented using programmatic modules, through the use of instructions that are executable by one or more processors. A programmatic module can include a program, a sub-routine, a portion of a program, or a software component or a hardware component capable of performing one or more stated tasks or functions. As used herein, a programmatic module can exist on a hardware component independently of other modules or components, or can be a shared element of other modules, programs or machines.

One or more embodiments described herein provide that methods, techniques, and actions performed in a digital simulation computing system are performed programmatically, or as a computer-implemented method. Programmatically, as used herein, means through the use of code or computer-executable instructions. These instructions can be stored in one or more memory resources incorporated in, or accessible to, the digital simulation computing system.

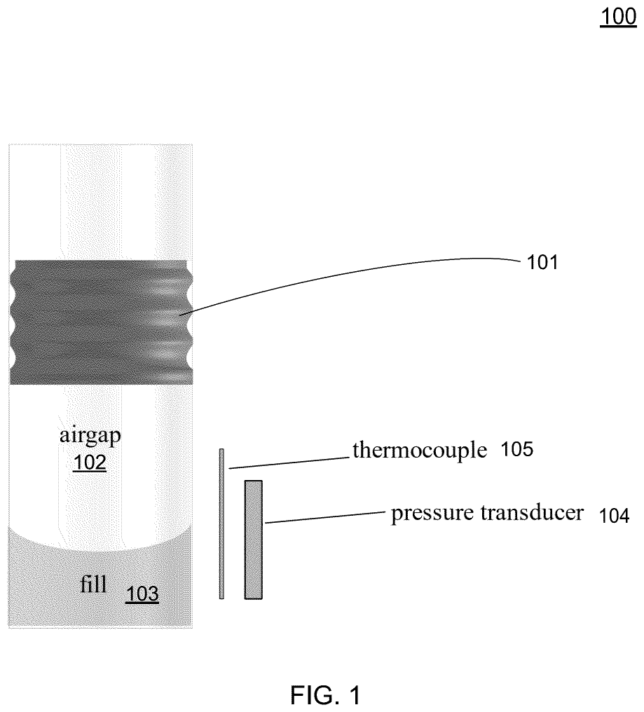

FIG. 1 illustrates, in an example embodiment, pre-filled vial 100 configured for autoclaving. In operation, pre-filled vial 100 (also referred to herein as vial 100) may contain drug product fill 103, with an air or other gaseous gap 102 formed within the vial, with both the air gap 102 and drug product fill 103 being enclosed within vial 100 by rubber stopper 101. Vial 100, in some embodiments, may be constructed of glass or a polymer material. The air gap 102 may be introduced during filling of the syringe with the drug constituents. During the autoclaving process performed in an autoclave chamber for sterilizing the vial 100, the pressure differential between gas in the enclosed air gap 102 and the progressively increasing (or decreasing, in some aspects) pressure and temperature outside of the stopper 101 causes a correspondingly varying force that tends to displace the stopper within vial 100. Once pressure differential-based force overcomes the static frictional forces keeping stopper 101 engaged with the internal surface of vial 100, stopper 101 is displaced from its initial position within vial 100, whereupon the vial contents, or fill, can be placed at high risk of compromise.

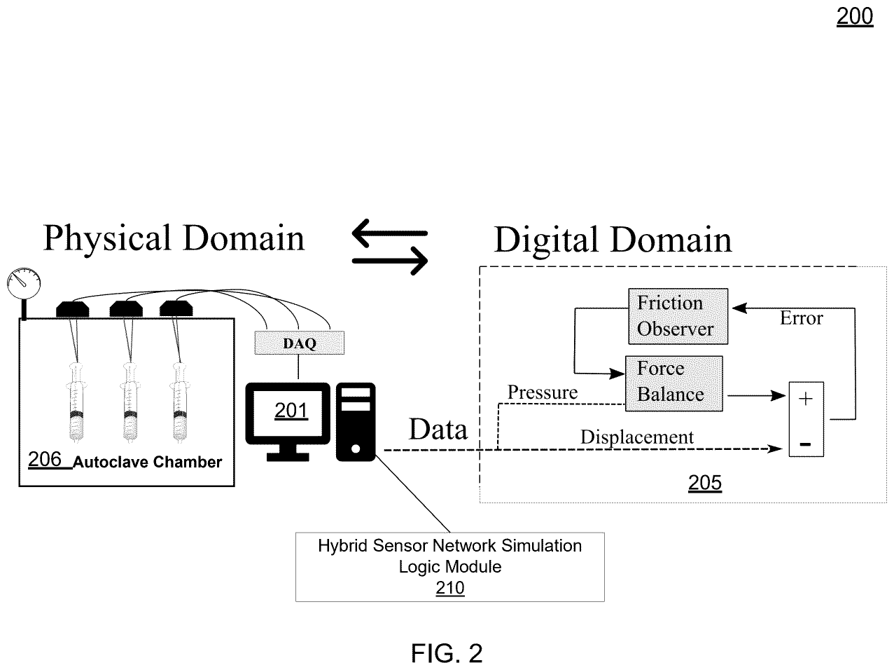

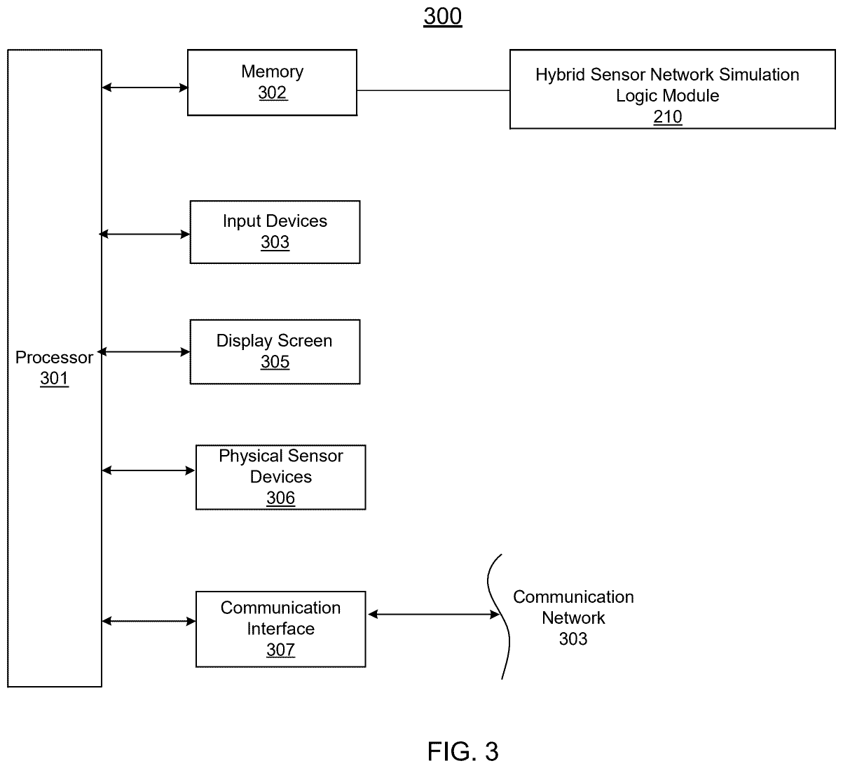

FIG. 2 illustrates, in an example embodiment, scheme 200 for digital simulation based on hybrid sensor network in autoclaving of a pre-filled vial. Digital simulation computing system 201 includes hybrid sensor network simulation logic module 210 which consists of instructions, stored in a computer readable memory, the instructions being executable in a processor of digital simulation computing system 201. PID controller block 205 which includes a PID friction observer, is deployed to simulate or model the operational integrity of pre-filled vial 100, as will be described in further detail with reference to FIGS. 3 through 5 herein. Physical domain 206 includes physical sensors providing data representative of the autoclave pressure and temperature conditions, used in conjunction with digital domain 205 which models underlying tribology and frictional mechanical characteristics inherent to vial and stopper at surfaces or areas of engagement or overlap.

FIG. 3 illustrates, in an example embodiment, computing device architecture 300 for digital simulation based on a hybrid sensor network in autoclaving of a pre-filled vial. In an example embodiment, computing system architecture 300 may be implemented in computing system 201, which may be server computing device, a desktop computing device, a laptop computing device, or similar computing device. Computing system 201, in embodiments, may include processor 301, memory 302, input devices 303, display screen 305 and be communicatively interconnected via communication interface 307 that is communicatively coupled with communication network 303.

In embodiments, computing system 201 can be interfaced or communicatively coupled with sensor devices 306, including pressure and laser displacement sensor devices. Laser displacement data can be acquired from physical domain 206 of the embodiment depicted in FIG. 2, representative of the underlying tribology including stopper sliding contact characteristics for a given pair of engagement surfaces formed by way of overlap between stopper 101 within vial 100. In one embodiment, the stopper may be of rubber or similar elastomer material, the vial of constructed of glass, and the PID friction compensation or observer model is based at least in part upon elastomer-glass surface asperities. Sensor data, pressure and displacement, may be fused with the system dynamics to infer friction via the PID friction observer of the PID controller block.

Processor 301 can be implemented in an application specific integrated circuit (ASIC) device or field programmable gate array (FPGA) device, in some embodiments. Memory 302 may comprise any type of non-transitory computer readable memory, storing instructions that are executable in processor 301, including such as a static random access memory (SRAM), dynamic random access memory (DRAM), synchronous DRAM (SDRAM), read-only memory (ROM), or any combination thereof.

Hybrid sensor network simulation logic module 210, in embodiments, may be constituted of processor-executable instructions for instantiating a simulation module that simulates frictional disengaging of a stopper that is engaged with a pre-filled vial responsive to a progressively varying autoclave chamber pressure and temperature. In particular, the processor-executable instructions instantiate operations for simulating a proportional-integral-derivative (PID) controller block, a frictional disengaging of a stopper that is engaged with a pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper. Then, generating, by the processor based on the progressively varying physical conditions, a measure corresponding to a stopper displacement in accordance with the frictional disengaging, and packaging the pre-filled vial based at least in part on the generated stopper placement.

Outputs of hybrid sensor network simulation logic module 210 comprise one or more of a stopper displacement, a stopper velocity and stopper friction characteristics, based on transitions from static friction to sliding friction forces.

In embodiments, the pre-filled vial comprises a pre-filled syringe. The vial may be constructed of a glass or a polymer material, and also any combination thereof. The stopper may be constructed of an elastomer material, such as, but not limited to, rubber.

In some embodiments, the virtual sensor of frictional characteristics in accordance with the digital simulation model may based on a proportional-integral-derivative (PID) controller block that includes a PID observer. In some aspects, the PID observer models frictional mechanics of the stopper relative to a surface of the pre-filled vial with which the stopper is engaged in accordance with a PID friction compensation model. In some particular embodiments, the PID friction compensation model is based at least in part upon elastomer-glass surface asperities and frictional characteristics inherent thereto.

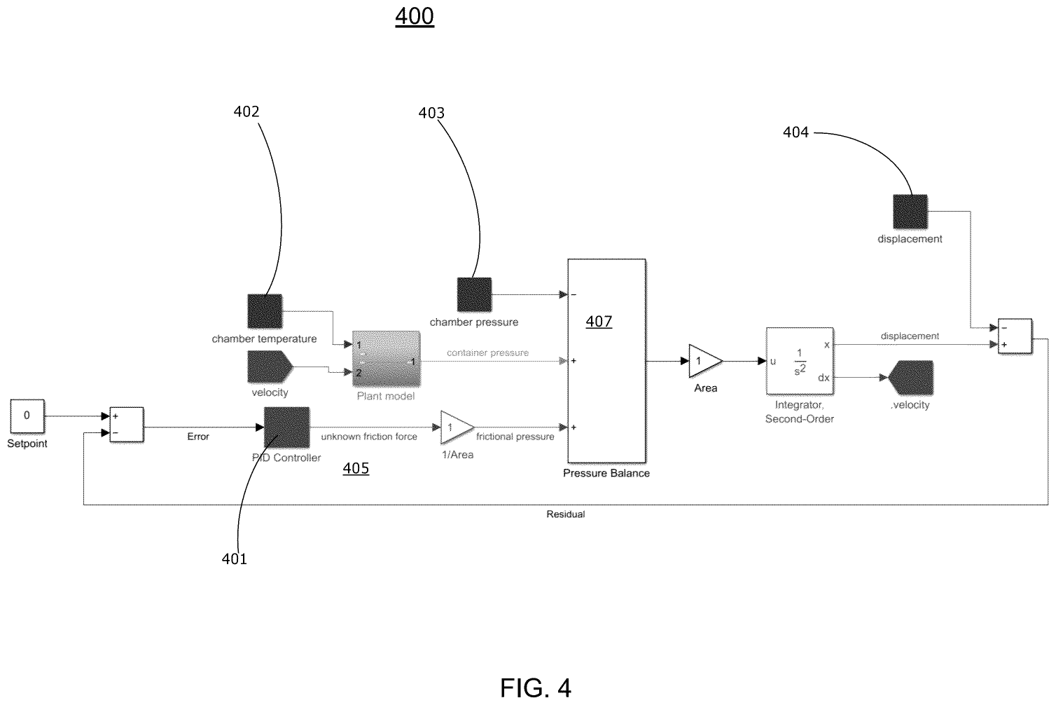

FIG. 4 illustrates, in an example embodiment, architecture 405 of a proportional-integral-derivative (PID) controller block for digital simulation based on a hybrid sensor network in autoclaving of a pre-filled vial. In embodiments, PID controller block 405 includes friction observer 401 in conjunction with pressure balance 407 model, chamber pressure data 403, chamber temperature data 402 and simulated stopper displacement 404. Friction observer 401 is used for friction compensation based on stopper 101 displacement tracking. In embodiments of the hybrid senor network as referred to herein, the virtual sensor provides sensor data based on modeling frictional mechanics of the stopper relative to a surface of the pre-filled vial with which the stopper is engaged in accordance with a PID friction compensation model, deployed in conjunction with physical sensors for chamber pressure data 403, chamber temperature data 402.

In some embodiments, the simulation model structure may be derived in part on:

$$m \frac{dv}{dt} = ( \frac{nRT}{V ( t )} - {P}_{atm} ( t ) ) A - f$$

$$\frac{dV}{dt} = vA$$

where m represents the stopper mass, v is the stopper velocity, and the airgap pressure is product of n moles of air, the ideal gas constant R, and the absolute temperature T divided by the airgap volume V; furthermore, Pₐₜₘ is the atmospheric or cabin pressure, A the cross-sectional area, f is the friction force, and the pressure differential ΔP is represented by the difference equation in parenthesis. Equation 2 reflects the coupling between the stopper's velocity and the airgap 102 volume.

In related aspects, friction observation/compensation may be based on implementation detail for PID controller block 405 as follows:

$$u ( t ) = {k}_{c} e ( t ) + \frac{{k}_{c}}{{τ}_{i}} {\int }_{0}^{t} e ( τ ) d τ + {k}_{c} {τ}_{d} \frac{de ( t )}{dt}$$

With transfer function implemented, in one specific simulation embodiment:

$$u ( s ) = P + I ( \frac{1}{s} ) + D ( \frac{Ns}{s + N} )$$

PID tuning parameters may be automatically estimated, in a particular simulation embodiment, using optimization techniques to minimize the sum squared error of the residual signal, where the cost function is given by:

$$F ( x ) = {\sum }_{t = 0}^{t = N} {r ( t )}^{2}$$

In one embodiment, inputs to the digital simulation model include one or more of a temperature and a pressure profiles in accordance with the progressively varying physical conditions of the autoclave chamber, a measured pressure provided by a first of the physical sensors, a measured temperature provided by a second of the physical sensors, and a set of PID tuning parameters. Outputs of the digital simulation model 405 can be a stopper displacement and/or a stopper velocity within the pre-filled vial.

In embodiments, PID controller block 405 performs a dual function, not only for friction identification as described herein, but also air overpressure identification. The air overpressure identification constitutes the process control signal in accordance with deploying PID controller block 405 in design of the vial sterilization process in context of steam-air mixture autoclave chambers. The air overpressure as referred to herein constitutes the pressure of air that is injected into the autoclave chamber during a steam-air mixture sterilization cycle in order to reduce the differential pressure acting across the seal of the pre-filled vial. In an embodiment, the differential pressure constitutes the difference between the pressure inside the container and the pressure outside of the container. By controlling the differential pressure in accordance with pressure balance model 407, likelihood of container breakage or unintentional seal motion can be minimized. In an embodiment, air is selected, instead of steam, since the chamber pressure can be modified practically independently of the chamber temperature.

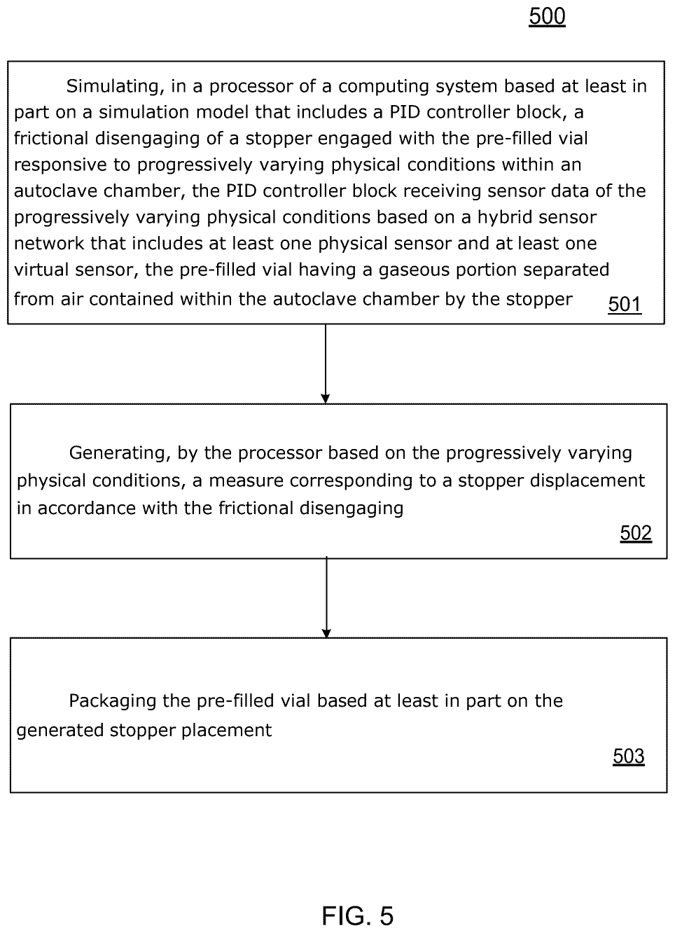

FIG. 5 illustrates, in an example embodiment, method 500 of operation based on a hybrid sensor network in autoclaving for packaging a pre-filled vial. Examples of method steps described herein are related to deployment and use of digital simulation computing system 300 used in conjunction with any components, systems and steps and techniques disclosed in conjunction with FIGS. 1-4 herein. According to some embodiments, the techniques are performed in processor 301 executing one or more sequences of software logic instructions that constitute hybrid sensor network simulation logic module 210. In embodiments, instructions constituting hybrid sensor network simulation logic module 210 may be read into memory 302 from machine-readable medium, such as memory storage devices. Executing the instructions of hybrid sensor network simulation logic module 210 stored in memory 302 causes processor 301 to perform the process steps of FIGS. 5-7 described herein. In alternative implementations, at least some hard-wired circuitry, including but not limited to application specific integrated circuits (ASICS) and field-programmable gate arrays (FPGA's) may be used in place of, or in combination with, the software logic instructions to implement examples described herein. Thus, the examples described herein are not limited to any particular combination of hardware circuitry and software instructions.

At step 501, simulating, in processor 301 of computing system 200 based at least in part on a simulation model that includes proportional-integral-derivative (PID) controller block 405, a frictional disengaging of a stopper that is engaged with the pre-filled vial responsive to progressively varying physical conditions within an autoclave chamber. The PID controller block receives sensor data of the progressively varying physical conditions based on a hybrid sensor network that includes at least one physical sensor and at least one virtual sensor. The pre-filled vial includes a gaseous portion that is separated from air contained within the autoclave chamber by the stopper.

At step 502, generating, by the processor 301 based on the progressively varying physical conditions, a measure corresponding to a stopper displacement in accordance with the frictional disengaging.

At step 503, packaging the pre-filled vial based at least in part on the generated stopper displacement.

In some embodiments, the pre-filled vial comprises a pre-filled syringe. The vial may be constructed of a glass or a polymer material, and also any combination thereof. The stopper may be constructed of an elastomer material, such as, but not limited to, rubber.

In embodiments, the digital simulation model may based on a proportional-integral-derivative (PID) controller block that includes a PID observer. In some aspects, the PID observer models frictional mechanics of the stopper relative to a surface of the pre-filled vial with which the stopper is engaged in accordance with a PID friction compensation model. In some particular embodiments, the PID friction compensation model is based at least in part upon elastomer-glass surface asperities and frictional characteristics, both static and dynamic, inherent thereto.

In some aspects, the simulation model comprises a set of outputs from the PID controller block, the set of outputs comprising one or more of a stopper displacement, a stopper velocity and a stopper friction characteristic. In embodiments, the autoclave chamber conditions at which the frictional disengaging is initiated may be generated based at least in part on the set of outputs.

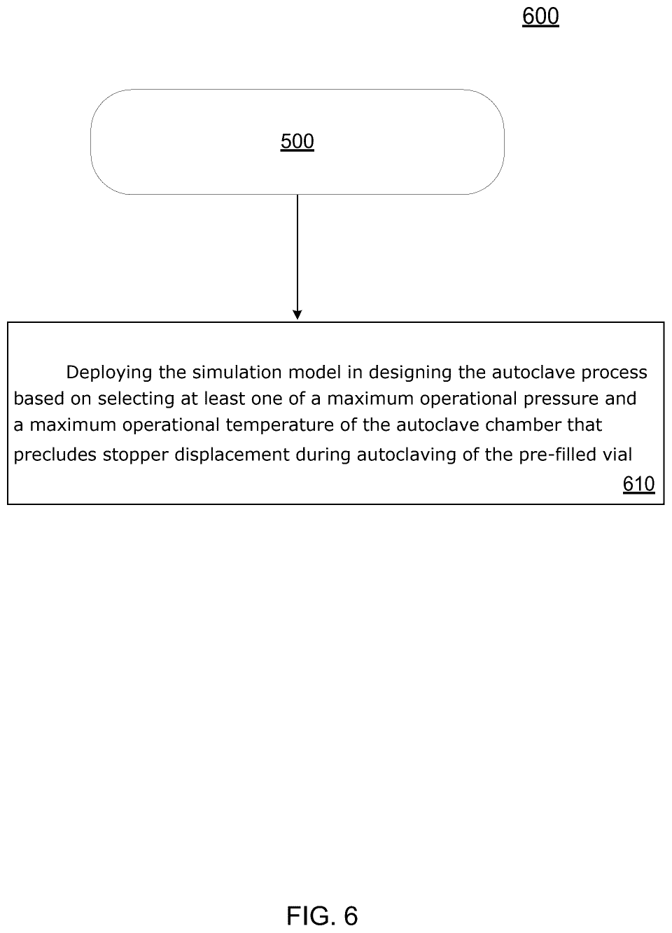

FIG. 6 illustrates, in an example embodiment, method 600 of deploying a simulation model based on a hybrid sensor network in designing an autoclave process for the pre-filled vial. Examples of method steps described in FIG. 6 are related to deployment and use of digital simulation computing system 300 used in conjunction with any components, systems and steps and techniques disclosed in conjunction with FIGS. 1-5 herein.

At step 610, deploying the simulation model in designing an autoclave process for the pre-filled vial. In embodiments, deploying the simulation model in designing the autoclave process comprises selecting at least one of a maximum operational pressure and a maximum operational temperature of the autoclave chamber that precludes stopper displacement during autoclaving of the pre-filled vial.

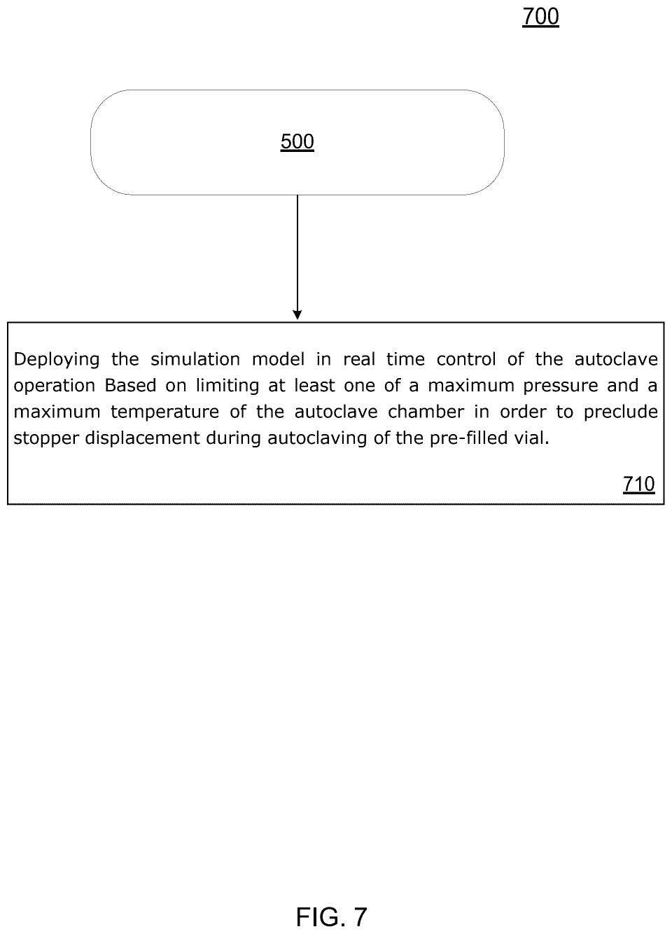

FIG. 7 illustrates, in an example embodiment, method 700 of deploying a simulation model based on a hybrid sensor network in real time control of an autoclave operation performed on a pre-filed vial. Examples of method steps described in FIG. 7 are related to deployment and use of digital simulation computing system 300 used in conjunction with any components, systems and steps and techniques disclosed in conjunction with FIGS. 1-6 herein

At step 710, deploying the simulation model in real time control of an autoclave operation performed on a pre-filed vial. In some embodiments, deploying the simulation model in real time control of the autoclave operation comprises limiting at least one of a maximum pressure and a maximum temperature of the autoclave chamber in order to preclude stopper displacement during autoclaving of the pre-filled vial.

Although embodiments are described in detail herein with reference to the accompanying drawings, it is contemplated that the disclosure herein is not limited to only such literal embodiments. As such, modifications and equivalents of the digital computing system-based simulation of operational integrity of pre-filled vials, and variations in sequence of the method steps in conjunction with varying combinations of features disclosed herein will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments described herein. Thus, absence of any described particular combinations of such does not preclude the inventor from claiming rights to such combinations.

What is claimed is:

1. A method of packaging a pre-filled comprising:
simulating, in a processor of a computing system based at least in part on a simulation model that includes a proportional-integral-derivative (PID) controller block, a frictional disengaging of a stopper that is engaged with the pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper;
generating, by the processor based on the progressively varying physical conditions, a measure corresponding to a stopper displacement in accordance with the frictional disengaging; and
packaging the pre-filled vial based at least in part on the generated stopper placement.

2. The method of claim 1 wherein the pre-filled vial comprises a pre-filled syringe.

3. The method of claim 1 wherein the vial comprises at least one of a glass and a polymer material, and the stopper comprises an elastomer material.

4. The method of claim 1 wherein the at least one virtual sensor provides sensor data based on modeling frictional mechanics of the stopper relative to a surface of the pre-filled vial with which the stopper is engaged in accordance with a PID friction compensation model.

5. The method of claim 4 wherein the PID friction compensation model is based at least in part upon elastomer-glass surface asperities.

6. The method of claim 1 wherein the simulation model comprises a set of inputs to the PID controller block, the set of inputs comprising one or more of a temperature and a pressure profiles in accordance with the progressively varying physical conditions of the autoclave chamber, a measured pressure of the gaseous portion provided by a first of the at least one physical sensor, a measured temperature of the gaseous portion provided by a second of the at least one physical sensor, and a set of PID tuning parameters.

7. The method of claim 1 further comprising deploying the simulation model in designing an autoclave process for the pre-filled vial.

8. The method of claim 7 wherein deploying the simulation model in designing the autoclave process comprises selecting at least one of a maximum operational pressure and a maximum operational temperature of the autoclave chamber that precludes stopper displacement during autoclaving of the pre-filled vial.

9. The method of claim 1 further comprising deploying the simulation model in real time control of an autoclave operation performed on a pre-filed vial.

10. The method of claim 9 wherein deploying the simulation model in real time control of the autoclave operation comprises limiting at least one of a maximum pressure and a maximum temperature of the autoclave chamber in order to preclude stopper displacement during autoclaving of the pre-filled vial.

11. An apparatus for packaging a pre-filled vial comprising:
one or more processors; and
a memory storing instructions executable in the one or more processors, the instructions when executed causing the one or more processors to implement operations comprising:
simulating, in the one or more processors based at least in part on a simulation model that includes a proportional-integral-derivative (PID) controller block, a frictional disengaging of a stopper that is engaged with the pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper;
generating, by the one or more processors based on the progressively varying physical conditions, a measure corresponding to a stopper displacement in accordance with the frictional disengaging; and
packaging the pre-filled vial based at least in part on the generated stopper displacement.

12. The computer simulation system of claim 11 wherein the pre-filled vial comprises a pre-filled syringe.

13. The computer simulation system of claim 11 wherein the vial comprises at least one of a glass and a polymer material, and the stopper comprises an elastomer material.

14. The computer simulation system of claim 11 wherein the at least one virtual sensor provides sensor data based on modeling frictional mechanics of the stopper relative to a surface of the pre-filled vial with which the stopper is engaged in accordance with a PID friction compensation model.

15. The computer simulation system of claim 14 wherein the PID friction compensation model is based at least in part upon elastomer-glass surface asperities.

16. The computer simulation system of claim 11 wherein the simulation model comprises a set of inputs to the PID controller block, the set of inputs comprising one or more of a temperature and a pressure profiles in accordance with the progressively varying physical conditions of the autoclave chamber, a measured pressure of the gaseous portion provided by a first of the at least one physical sensor, a measured temperature of the gaseous portion provided by a second of the at least one physical sensor, and a set of PID tuning parameters.

17. The computer simulation system of claim 11 further comprising deploying the simulation model in designing an autoclave process for the pre-filled vial.

18. The computer simulation system of claim 17 wherein deploying the simulation model in designing the autoclave process comprises selecting at least one of a maximum operational pressure and a maximum operational temperature of the autoclave chamber that precludes stopper displacement during autoclaving of the pre-filled vial.

19. The computer simulation system of claim 11 further comprising deploying the simulation model in real time control of an autoclave operation performed on a pre-filed vial.

20. A non-transitory computer readable memory storing instructions that are executable in one or more processors, the instructions when executed causing the one or more processors to implement operations comprising:
simulating, in the one or more processors based at least in part on a simulation model that includes a proportional-integral-derivative (PID) controller block, a frictional disengaging of a stopper that is engaged with a pre-filled vial responsive to progressively varying physical conditions within an autoclave chamber, the PID controller block receiving sensor data of the progressively varying physical conditions based on a hybrid sensor network that includes at least one physical sensor and at least one virtual sensor, the pre-filled vial containing a gaseous portion that is separated from air contained within the autoclave chamber by the stopper,
generating, by the one or more processors based on the progressively varying physical conditions, a measure corresponding to a stopper displacement in accordance with the frictional disengaging; and
packaging the pre-filled vial using based at least in part on the generated stopper displacement.
